(19) United States
(12) Patent Application Publication
(10) Pub. No.: US 2015/0021333 A1
(43) Pub. Date: Jan. 22, 2015

(54) Container Two

(71) Applicant: William Warren, Frisco, TX (US)

(72) Inventor: William Warren, Frisco, TX (US)

(21) Appl. No.: 14/275,907

(22) Filed: May 13, 2014

Related U.S. Application Data
(60) Provisional application No. 61/855,361, filed on May 14, 2013.

(51) Int. Cl. B65F 1/06; B65F 1/14

(52) U.S. Cl. CPC B65F 1/06; B65F 1/1415
USPC 220/495.08

(57) ABSTRACT

The trash container for collecting trash may include an outer container having a first cavity and an inner container being connected to the outer container being positioned within the first cavity. The outer container may include a bottom first wall opposing first walls and a back first wall to define the first cavity. The inner container may include a bottom inner wall, the opposing inner sidewalls and aback inner wall to define a second cavity. The cavity between walls of outer an inner would be created. A cavity would be created in between the inner walls also.

### PRIORITY

The present application claims priority under 35 USC section 119 based upon a provisional application with Ser. No. 61/855,361 which was filed on May 14, 2013.

### FIELD OF THE INVENTION

The present invention relates to trash containers and more particularly to a trash container having flexible walls.

### BACKGROUND

Trash is a common problem around the home, office and out of doors. In order to collect this trash, trash cans have been used. However, these trash cans can be small and generally have rigid sidewalls. The rigid sidewalls prevent the trash cans from being flattened out and stored in a relatively small space. What is needed is a trash can which can be easily deployed and easily stored in a limited space.

### SUMMARY

A trash container for collecting trash may include an outer container having a first cavity and an inner container being detachably connected to the outer container and being positioned within the first cavity. The outer container may include a bottom first wall, opposing first side walls and a back first wall to define the first cavity. The inner container may include a bottom inner wall, the opposing inner sidewalls and a back inner wall to define a second cavity.

The outer container may not have a front wall.

The inner container may not have a front wall.

The outer container may be inflatable by an inflation tube.

The inner container may be inflatable.

The inner container may include a inclined wall which extends from the back wall to the bottom wall.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a perspective view of the trash container of the present invention;

FIG. 2 illustrates a top perspective view of the trash container of the present invention;

FIG. 3 illustrates a perspective view of the trash container of the present invention;

FIG. 4 illustrates a perspective view of the trash container of the present invention;

FIG. 5 illustrates a top perspective view of the trash container of the present invention;

FIG. 6 illustrates a side perspective view of the trash container of the present invention;

FIG. 7 illustrates a front perspective view of the trash container of the present invention;

FIG. 8 illustrates a cross-sectional view of the trash container of the present invention;

FIG. 9 illustrates a top perspective view of the trash container of the present invention;

FIG. 9A illustrates a cross-sectional view of the trash container of the present invention;

FIG. 10 illustrates a perspective view of the trash container of the present invention;

FIG. 11 illustrates a cross-sectional view of the trash container of the present invention;

FIG. 12 illustrates a cross-sectional view of the trash container of the present invention;

FIG. 13 illustrates a cross-sectional view of the trash container of the present invention;

FIG. 14 illustrates a top perspective view of the trash container of the present invention;

FIG. 15 illustrates an exploded view of the trash container of the present invention;

FIG. 16 illustrates a cross-sectional view of the trash container of the present invention;

FIG. 17 illustrates a front perspective view of the trash container of the present invention;

FIG. 18 illustrates a front perspective view of the trash container of the present invention.

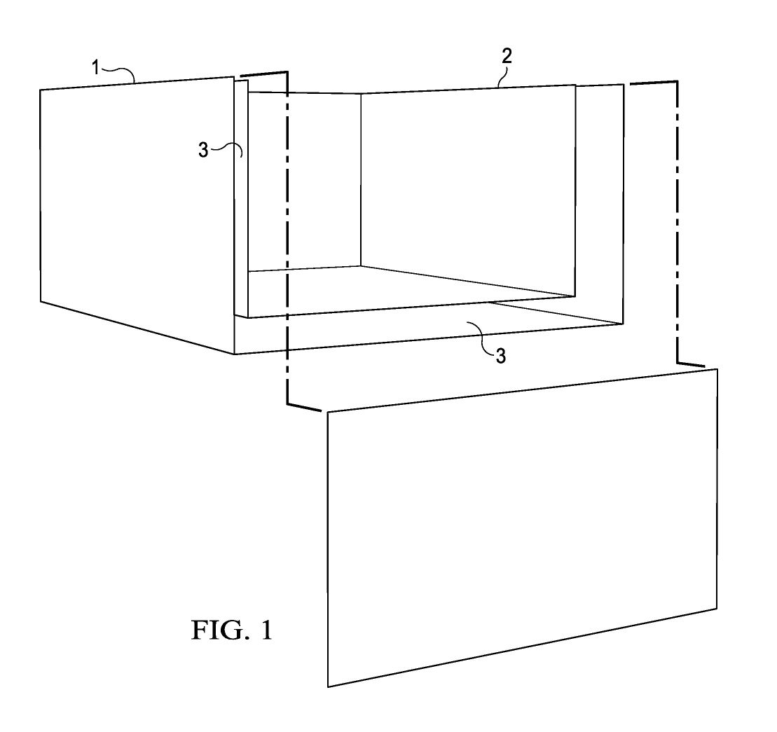

FIG. 1 Is a cross section looking into the front of device, with the front skin missing. 1 shows the outer shell. 2 is the inner shell. The shell made out of a hefty or glad or biodegradable materials or any other type of materials to be deemed effective. 3 shows where the air or liquid or space is produced by the outer shell 1 and the inner shell 2.

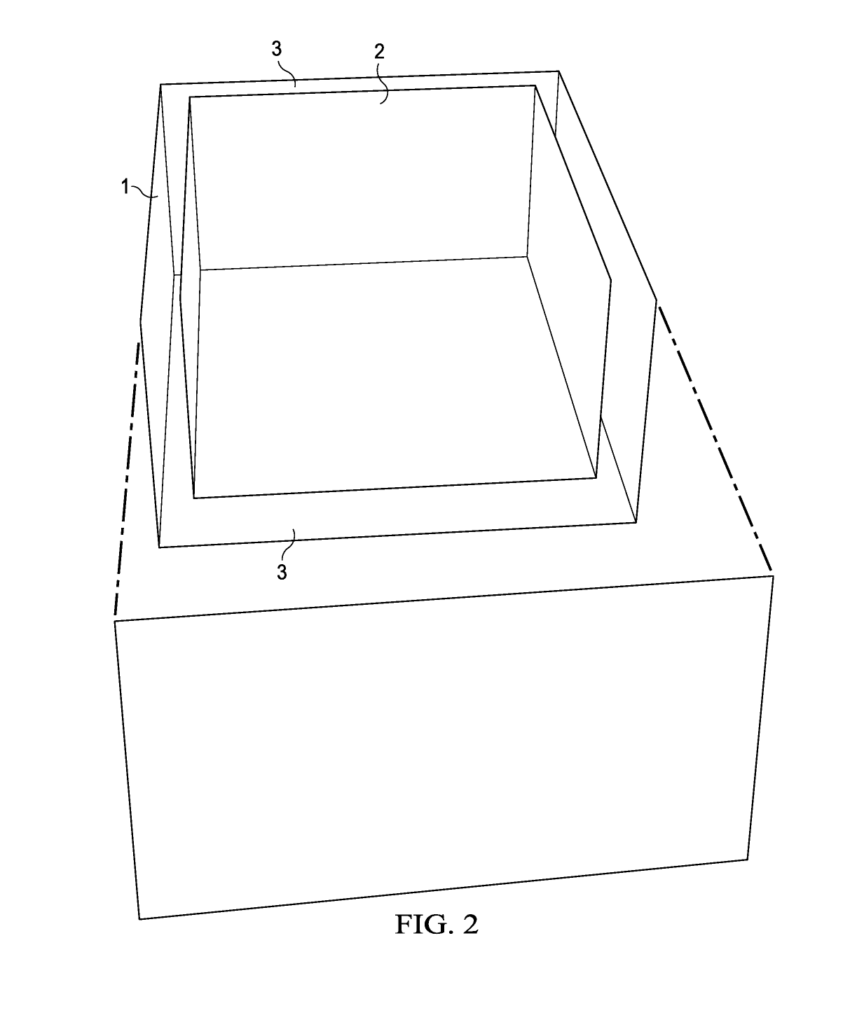

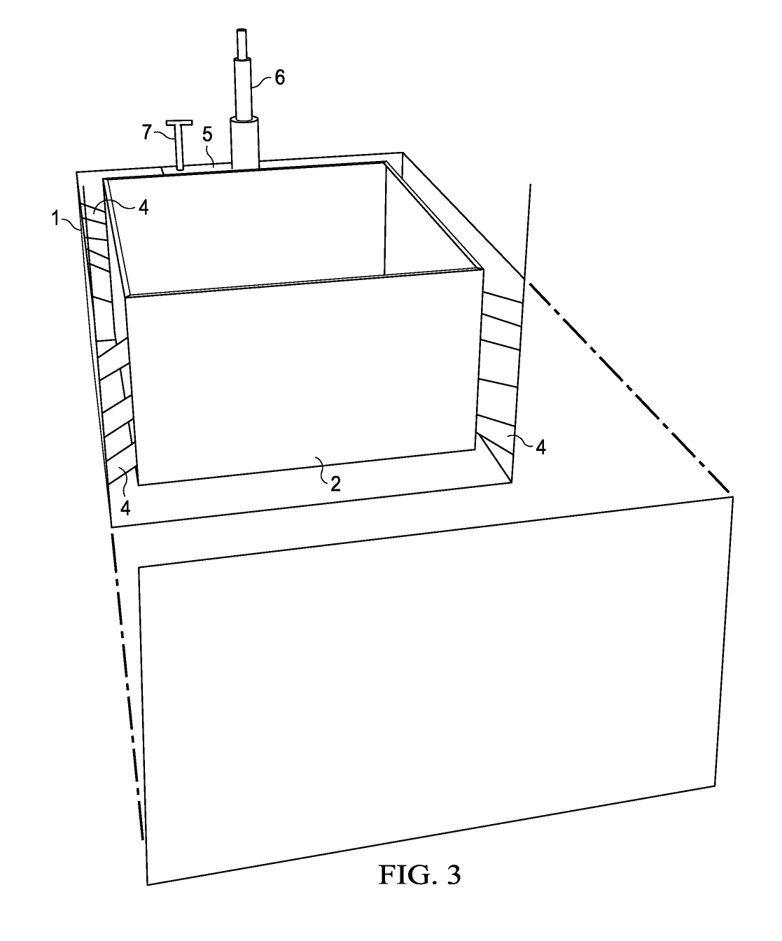

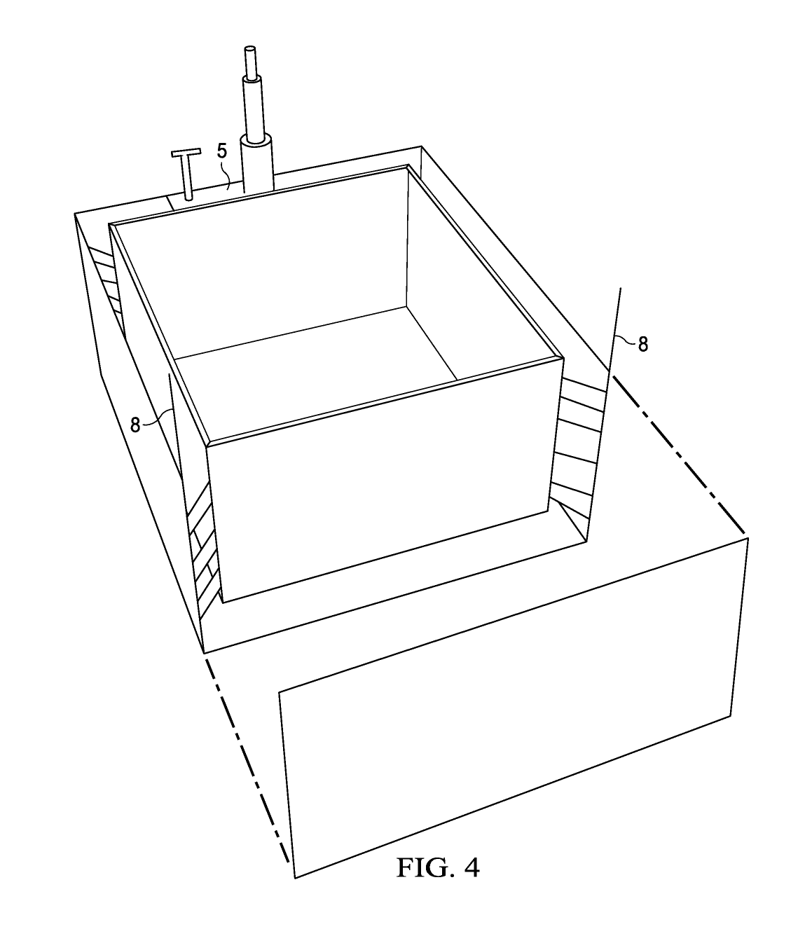

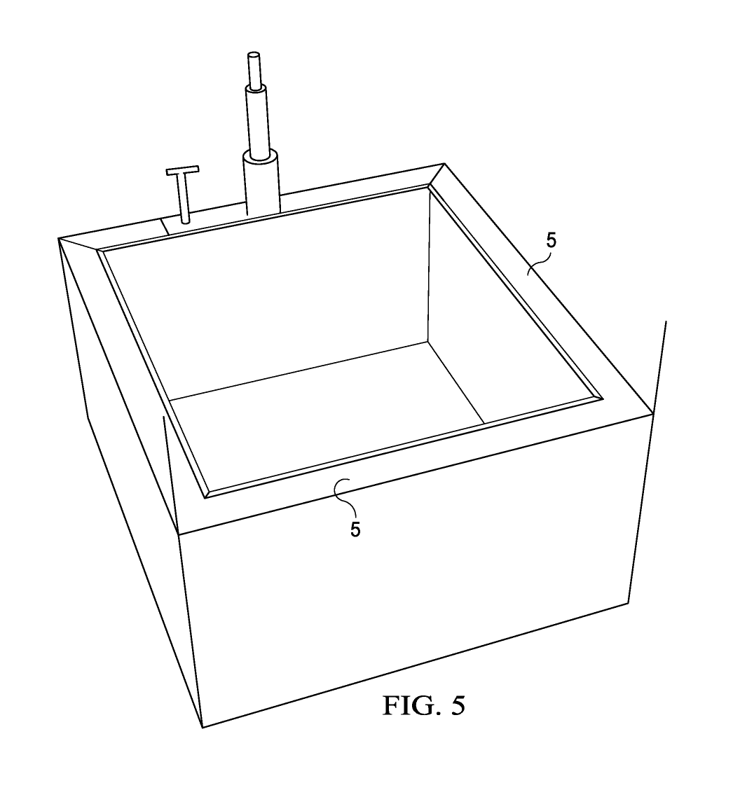

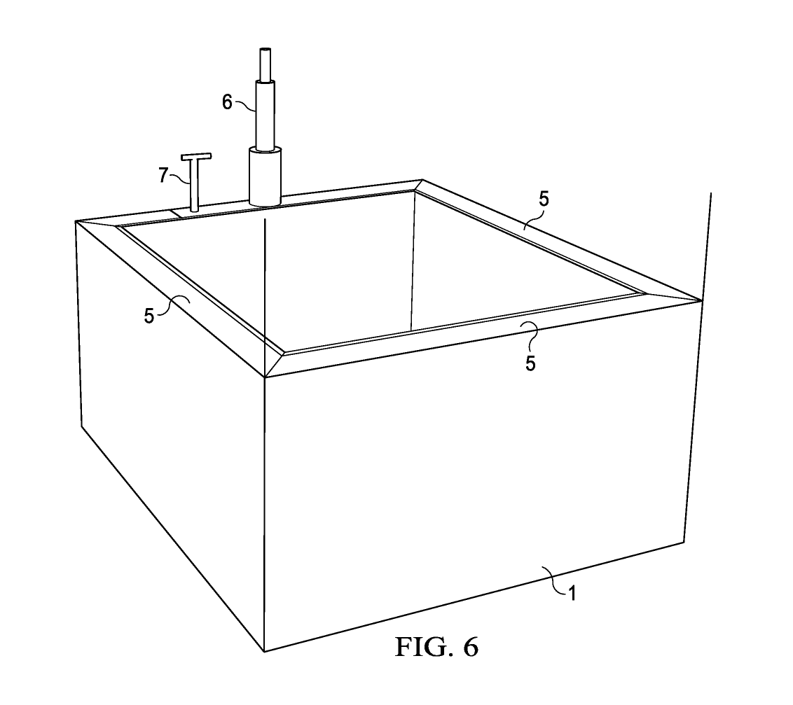

FIG. 2 Illustrates the space or area 3 from a different perspective. The space is a result of 1 and 2 being separated. FIG. 3 Illustrates 4, and 4 holds the outer shell 1 and inner shell 2 together in some fashion deemed to be structurally sound as to create a space for air or water etc. preferably made out of the same material as outer shell 1 and inner shell 2. This combination will produce an effect to create a chamber between shell 1 and shell 2 to trap air or liquid in the space or chamber sealed off on top 5. 5 is not shown at this time only partially. 6 show the blow tube to inflate the space in between 1 and 2 supported by 5. The blow tube can be inflated by human or co2 devices or electric or pump air devices. 7 is a cleat to tie cords or stings to keep dogs etc. in place FIG. 4 illustrates 8 which is a tie cord made of the same material as 1,2 and 5. For rapid discarding of waste. FIG. 5 show where 5 will go around on top of the device. FIG. 6 shows the outer shell 1 in place, FIG. 6 illustrates what you would be discovering if 5 and 6 are in place.

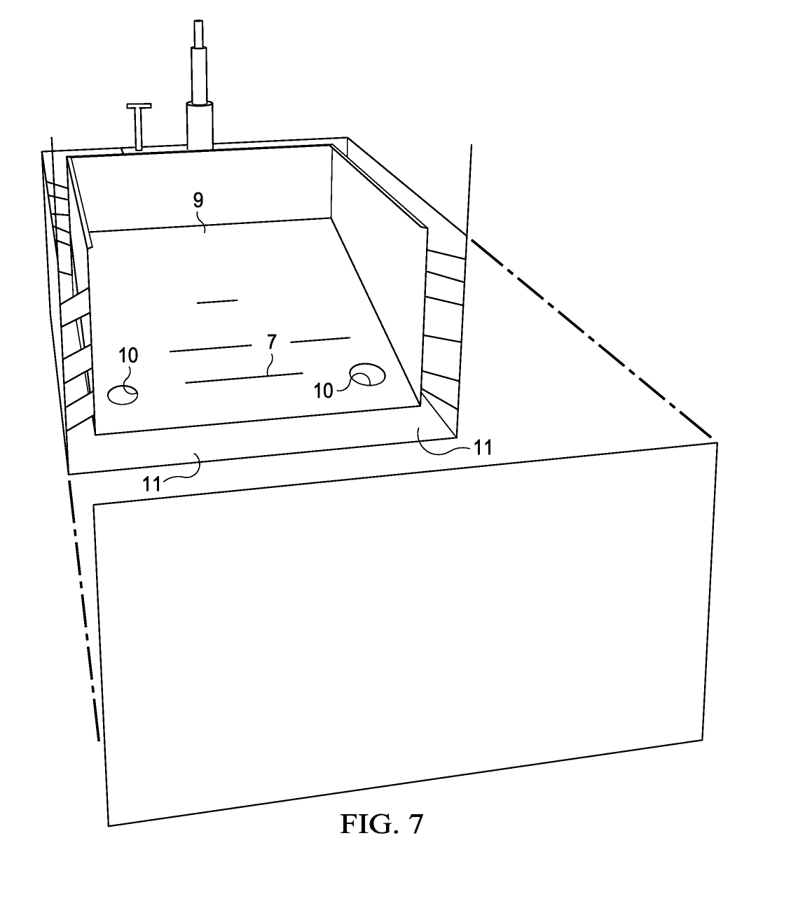

FIG. 7 illustrates a floor 9 that is at an incline, for solids or liquids to gravitate towards 10 which are holes or slats created to get trapped in 11. And also 11 could or could not have liquid or solid absorbing material.

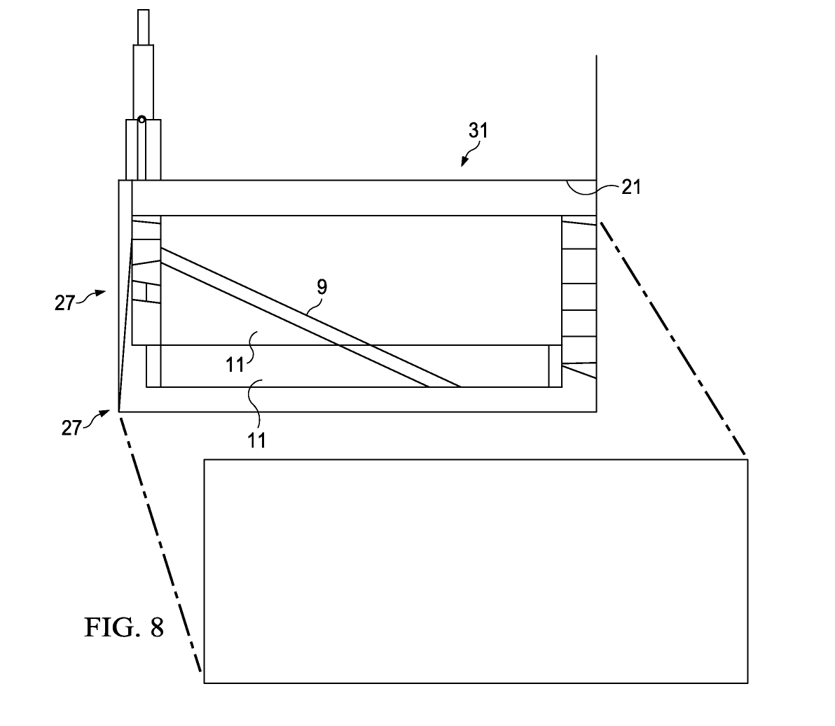

FIG. 8 illustrates 11 where solids and liquids get trapped with or without a urine or solid type of absorption material.

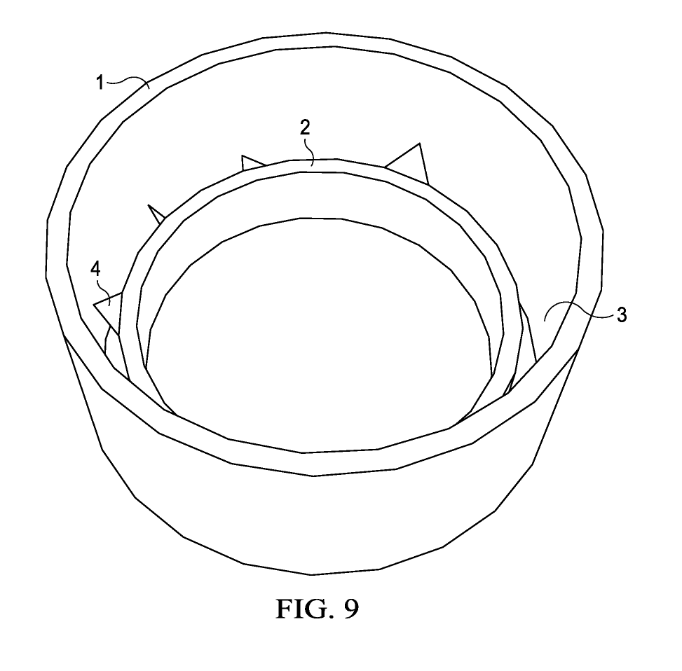

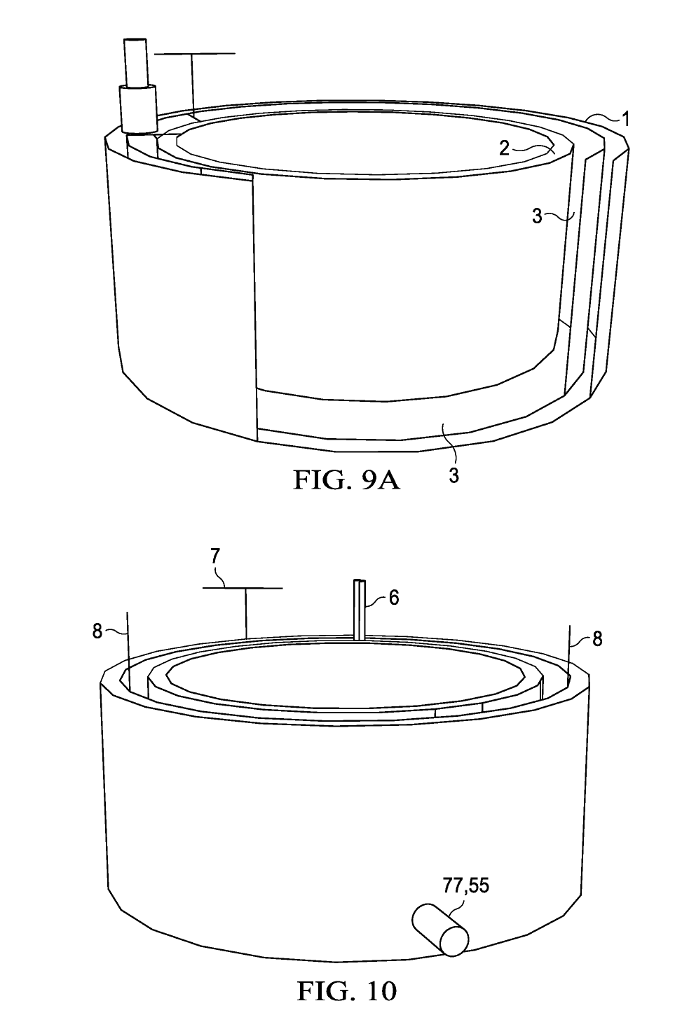

FIG. 9 illustrates an outer shell 1 an inner shell 2. 4 provide the materials to adhere 1 and 2 together with a space 3 as a result of 1 and 2 and 4.

FIG. 9a shows a cross section with a cut out of shell 1 and inner shell 2 with 3 space for air or liquid

FIG. 10 illustrates 6 a blow tube and 7 shows a cleat and 3 is the space and 8 is the tie cord.

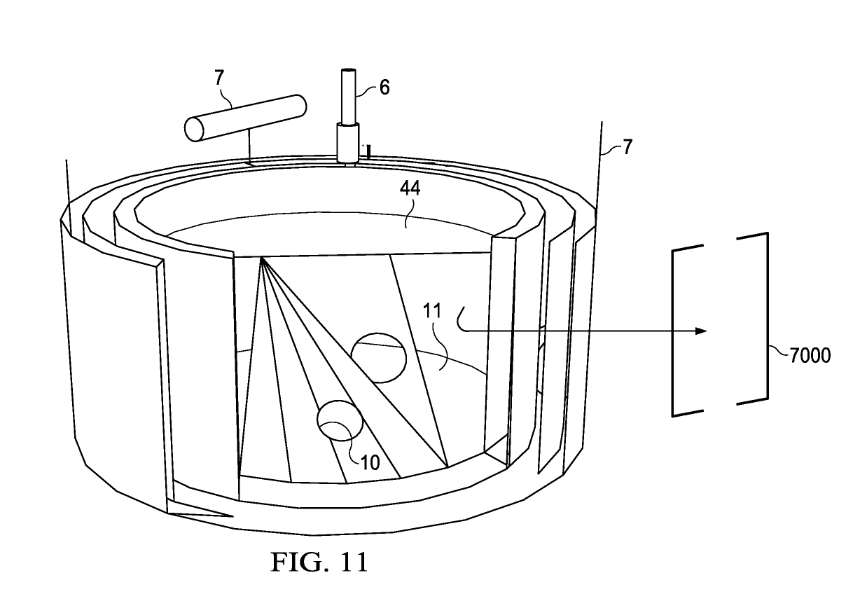

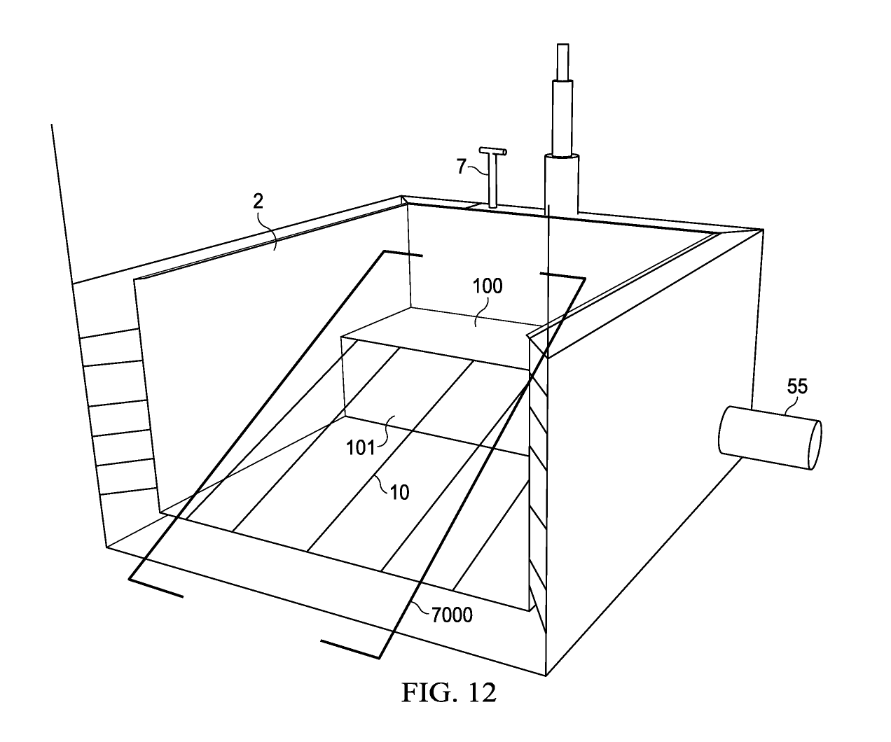

FIG. 11 illustrates 44 an area that is flat so a pet or any other animal or thing can rest. 9 is a floor at an incline. 10 are where solids or liquids can have access to 11. FIG. 12 100 is an inflatable support type bench to support an animal, human etc. and can be tied to the cleat 7 therefore solids and liquids will run by gravity to slats and holes 10. this bench or support can be done by inner shell 2 cutting the back that touches 3 and having a support wall 101.

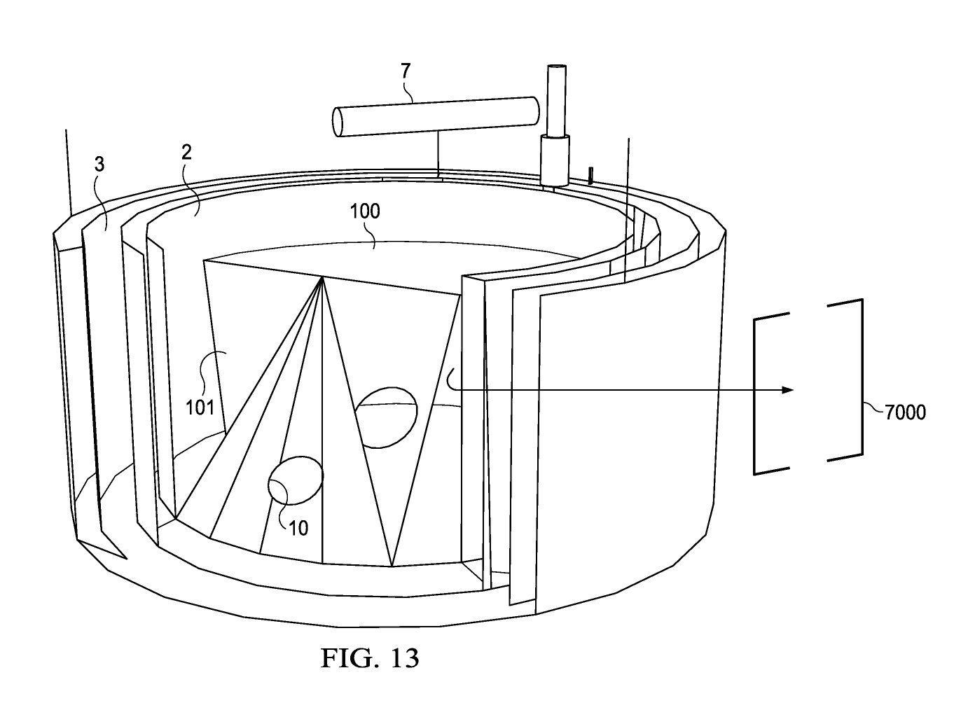

Therefore a continuous air space 3 uninterrupted by any blockage for easy blow up and disposal. 55 there is also an air release valve on all of the model or devices for air to escape fast when finished. FIG. 13 100 is an inflatable support for pets or anything else deemed to fit on bench. With cleat tie also 7. The space underneath the bench will be supported by air from the space in 3. The air under 100 can be engineered by removing the part of inner shell 2 that touches 3 and provide a wall 101 to seal off any air or liquid to form the bench.

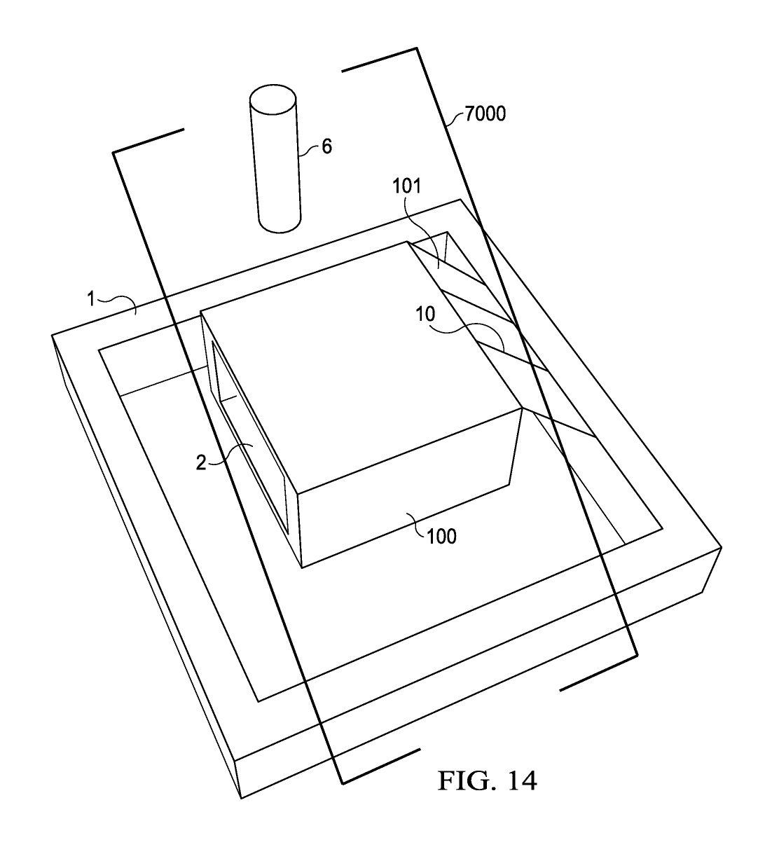

FIG. 14 illustrates the cross section of the bench 100. The bench was shown in FIG. 12. By isolating the bench 100 a separate blow tube 6 can be used to inflate the bench. The bench 100 could also be inflated when the frame is inflated 1. 007 is bottom floor. The wall 1 is not shown to full height. Wall 1 would be the normal height of trash container. 6 is shown that bench 100 can be inflated as a stand alone or with frame 1.

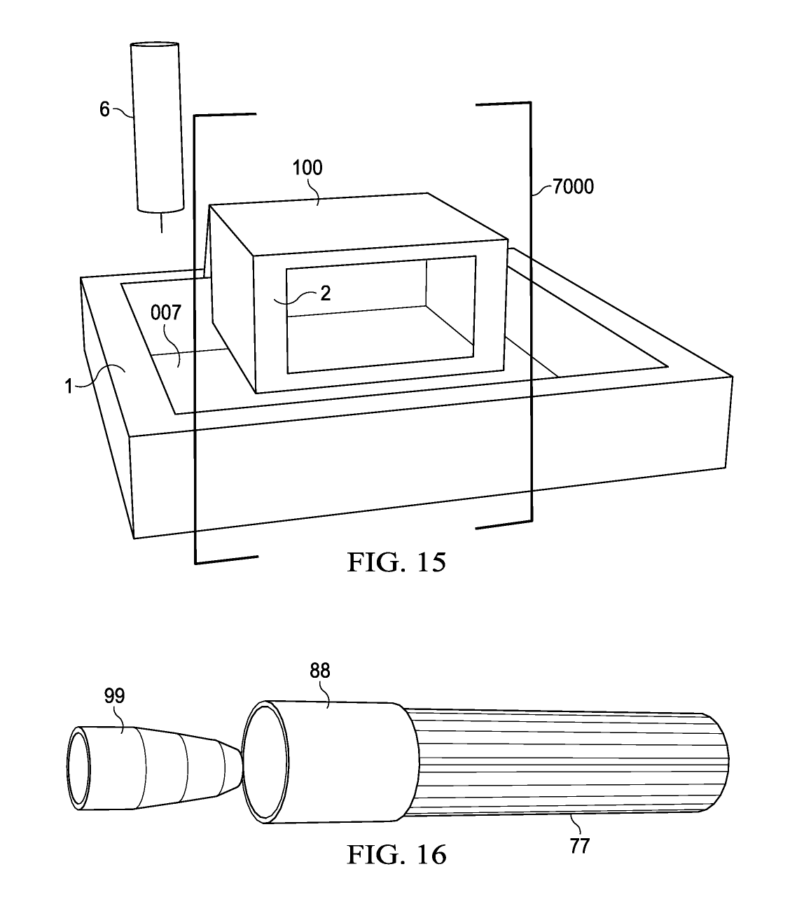

FIG. 15 is a different angle of FIG. 14

FIG. 15 shows another angle of support bench inflation system.

FIG. 16 demonstrates the blow tube with the regular tube 77 attached to structure for easy blow up, it may or may not be rigid. If not rigid it can be tied easily to cut off escaping air or after being tied it can be cut to release the air.

88 is a rigid piece to allow for air machines, co2 or any other devices to inflate the structure. 99 is a cap not unlike a inflatable pool raft.

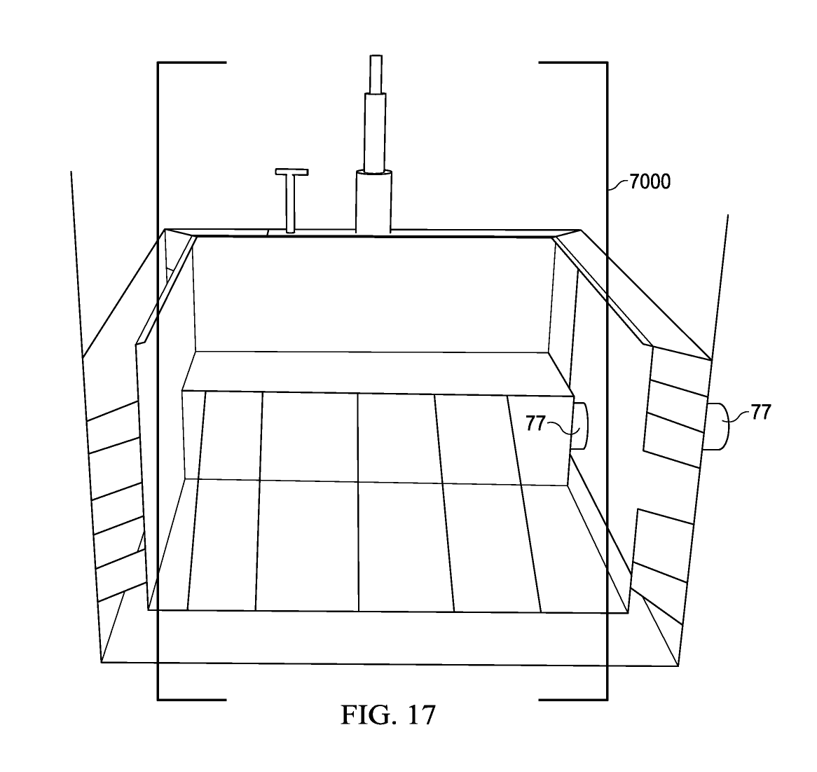

FIG. 17 illustrates the view of the pet bench 77 may or may not be there. 77 is a quick air or liquid release tube by cutting.

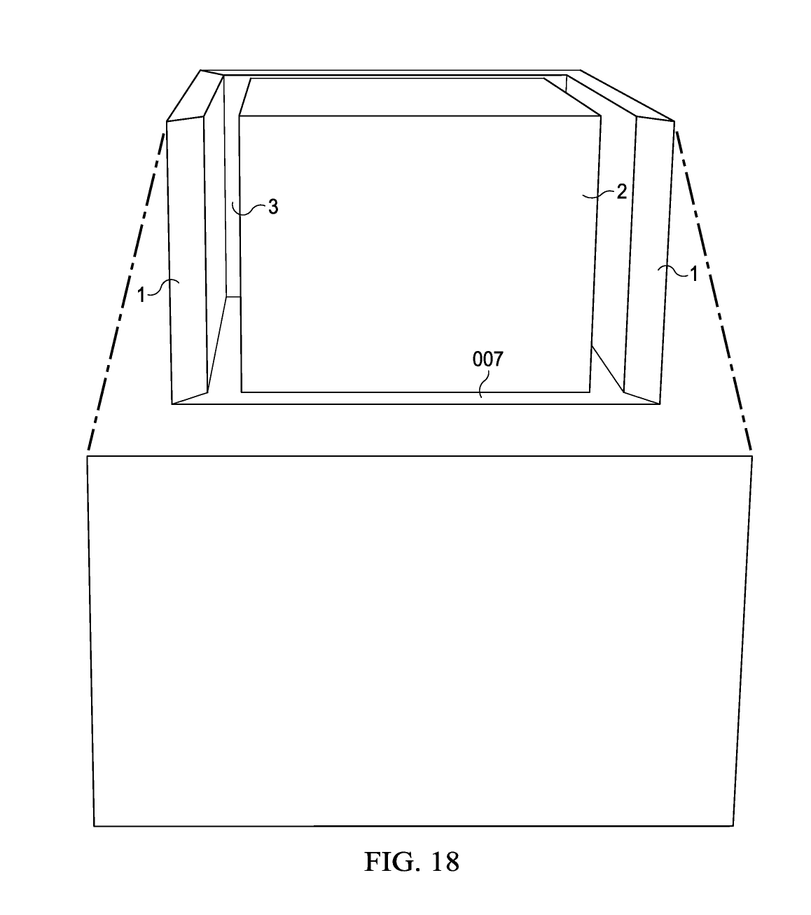

*FIG. 18 illustrates outer shell 1 and inner shell 2 with no air or liquid space in between 1 and 2 to form 007 on the bottom. *This may or may not exist with all systems. The two shells 1 and 2 essentially joined as 1 to form a bottom support for systems. Air or liquids will be formed on the periphery 3 to support the system.

*ALL OF THE INFLATION SYSTEMS MAY OR MAY NOT HAVE GROUND SUPPORT SYSTEMS

Bracket 7000 FIG. 14 This drawing is to show the “bench support”. The true function is to illustrate the isolation of the support or bench support to fit under any secondary floor that's not the lowest floor. The support is there to hold an animal on top so solids and fluids run down secondary floor. As illustrated other drawings, there will be holes in secondary floor. This is shown in FIG. 7 the inclined floor 51 and the holes or apertures or slits. The bench location is also shown in FIG. 17. The bench is 90

FIG. 15 is just another angle of figure FIG. 14. Inclined floor 51 has a view from underneath with holes in material to let out waste to flow to bottom floor. The isolation of the bench 90 is idea behind these drawings.

**ALL DEVICES COULD OR COULD NOT HAVE QUICK DEFLATING TUBES LOCATED ANYWHERE ON INFLATION SYSTEMS.

1) A trash container for collecting trash comprising: an outer container having a first cavity;
an inner container being detachable connected to the outer container and being positioned within the first cavity:
wherein the outer container including a bottom first wall, opposing first side walls and a back first wall defined a second cavity and the lowest floor or wall may be fused together or apart.

2) A trash container for collecting trash as in claim 1, wherein the inclined wall has a support bench that could be inflated along with frame or a separate inflation system.

3) A trash container for collecting trash as in claim 1, wherein the container is inflatable, in between outer shell and inner shell.

4) A trash container for collecting trash as in claim 1, wherein the inner container includes an inclined wall which extends from the back wall towards the bottom wall.

5) A trash container for collecting trash comprising:
an outer container having a first cavity;
an inner container positioned within the first cavity and having a second cavity for the trash: wherein the outer container and the inner container are connected by separators.

6) A trash container for collecting trash as in claim 5, wherein the inflatable tubes can be any shape to make a stable platform.
